(19) United States
(12) Patent Application Publication
(10) Pub. No.: US 2024/0140544 A1
(43) Pub. Date: May 2, 2024

(54) Anti-Slip Device

(71) Applicant: Pewag Schneeketten GmbH, Brückl (AT)

(72) Inventors: Hubert Schemitsch, Klagenfurt (AT); Georg Grossauer, Deutschlandsberg (AT); Stefan Spang, Bopfingen (DE)

(73) Assignee: pewag Schneeketten GmbH, Brückl (AT)

(21) Appl. No.: 17/974,806

(22) Filed: Oct. 27, 2022

(51) Int. Cl. B62D 55/28

(52) U.S. Cl. CPC B62D 55/28

(57) ABSTRACT

An anti-skid device for installation on a belt of a crawler vehicle or wheel of a wheel drive includes a base body which, along a direction which corresponds to the running direction of the crawler belt or wheel, has at least two bottom sections (which, in the installed state, rest on a running surface of the belt or wheel, and has at least one rib section which is curved upward and is arranged between two bottom parts. One or more fastening points are provided in the bottom sections for anchoring the anti-skid device to the belt. The rib section is supported on the bottom sections and is divided into two or more rib parts in the direction transverse to the running direction; in addition, recesses are provided in lateral flanks of the rib section. One or more traction elements that project away can be provided on the rib parts.

The invention relates to an anti-skid device which is configured for attachment to a running gear component of a drive means, especially a crawler belt of a crawler vehicle.

Anti-skid devices of the type considered here are intended to be installed on a running gear of a vehicle, more precisely on the components of the running gear coming into contact with the ground, such as especially a crawler belt, and are intended to improve the traction of the running gear on the ground. In the context of the invention, the running gear component is usually a crawler belt, but can generally also be a different component of a drive means that comes into contact with the ground, such as a wheel or wheel tire.

The anti-skid device considered here is preferably provided for use in a crawler drive of a crawler vehicle, but without being limited to said use. A crawler vehicle is generally understood here to mean a vehicle equipped with a crawler drive. In a crawler drive, a number of crawler belts, usually two, are used as the drive component for the purpose of locomotion. Each crawler belt can be formed, for example, as a continuous strip of elastic material (for example, rubber) which is closed in a ring-like manner to form an endless belt, or can be formed from a plurality of crawler pads which are connected to one another in a ring-like manner to form an (endless) closed chain. In the latter case, the crawler belt is also referred to as a crawler chain or caterpillar. The crawler belt or the crawler pads can be produced from different materials, especially from metal or plastic, for example an elastomer.

In this case, traction is understood to mean the force which is transmitted from a running gear component to a surface (usually the surface of a ground on which rests the running gear component), this force acting in a tangential direction to this surface. Usually, the traction for driving a vehicle with which the running gear component is associated is used.

As already mentioned, the anti-skid device serves to increase the traction of a crawler belt or wheel, wherein especially the lateral forces to be absorbed by the drive means (crawler belt) are of particular relevance. In the case of a crawler, this is due to the fact that crawlers, typically because of the geometry of their cleats, which are placed on the outer surface of the crawler pads, preferably transmit traction in the direction of travel. However, this can lead to the problem that, when traveling over inclined roadways on ice, snow, softened slopes, etc., slippage of the vehicle is possible-especially to the side. For example, in the transverse intersection of ski lift paths in the alpine region (there, ice is also frequently encountered, which additionally contributes to the risk of slipping), slippage is especially promoted and at the same time is especially undesirable.

Anti-skid devices of a conventional type frequently offer insufficient traction power in this regard. In addition, the fastening means on the crawler belt of many conventional anti-skid devices take up a considerable amount of space, especially on the lateral edge of the crawler, which is not only disruptive, but can also lead to contact with or even damage to the chassis of the vehicle.

Therefore, the invention is intended on the one hand to largely reduce or entirely prevent such slippage and on the other hand to enable space-saving fastening of the device to the respective running gear component.

This object is achieved by an anti-skid device of the type mentioned at the outset which comprises a base body and optionally one or more traction elements located thereon,
wherein the base body has a plurality of successive sections along a first direction-which, when installed on a running gear component, corresponds to the running direction of the running gear component-namely at least two bottom sections (which in the installed state are intended to rest on a part of the running surface of the crawler) and at least one rib section arranged in each case between two bottom sections and fixedly connected thereto, and which has a shape which is curved over the bottom sections and is supported thereon,
wherein the rib section or at least one of the rib sections is divided transversely to the first direction by at least one window into two or more rib parts, each having an outer surface facing away from the bottom sections,
wherein at least one fastening point for anchoring to a crawler belt is provided in the anti-skid device. If the anti-skid device has a traction element, the latter is provided on each of the outer surfaces projecting outward, i.e., projecting away from them.

This solution according to the invention improves the traction of the running gear, especially the crawler belt, especially with regard to the lateral forces to be absorbed. This can prevent or at least significantly reduce slippage, especially in the lateral direction. Furthermore, further parameters of the traction behavior, such as braking effect, acceleration effect, lane keeping during cornering and the like, are improved.

The anti-skid device of the invention is not restricted to crawler drives; it can also be used on other drive means or running gear components, for example wheels with pneumatic or solid rubber tires. The vehicle may, for example, be a civilian utility vehicle (e. g. a wheel-driven or crawler-driven tractor, a snow cat) or a drivable machine, such as a forestry machine, but may also be a military vehicle, such as a tank.

In an advantageous development of the invention, the base body can be designed such that the bottom sections and rib sections are integral with one another. In this case, two bottom sections are usually connected by at least two rib parts.

In another expedient development, the rib parts can be separate components which are joined together by suitable connecting means. The rib parts can transition into bottom parts adjoining both sides, wherein in each case the bottom parts belonging to a rib section on one side each are connected to one another by a cross brace extending transversely to the first direction, whereby the bottom parts together with the cross braces form the bottom sections.

The traction elements can be designed in various ways. For example, one or more traction elements protruding from the outer surface can be provided on one, on some or on each of the outer surfaces. Some or all of the traction elements welded to the outer surfaces of the rib parts can also be spike-type, bracket-type or web-type components.

Furthermore, it is possible, alternatively or in combination with what was described above, for at least one of the traction elements to be formed—for example, punched out—as a projecting formation of the rib part.

For a simple and yet effective implementation of the base body, it can be formed from one or more shaped sheet metal parts.

In order to achieve a reliable support on the support plate of the running gear component in question, it can be advantageous if the bottom sections have flat partial sections which, when installed on a crawler belt, are intended to rest against a surface of the crawler belt.

The rib parts can furthermore have flank sections on both sides of the outer surfaces, which flank sections extend at an angle of inclination to the outer surfaces and are intended to rest against rib side surfaces of the crawler belt when the anti-skid device is installed on a crawler belt, wherein window-like recesses are preferably provided in the flank sections.

The fastening points which serve to attach the device to the, for example, crawler belt, can advantageously be formed as openings in the bottom sections, by means of which fastening means for anchoring the anti-skid device can be detachably attached to the crawler belt.

Expediently, at least two fastening points can be provided in each base section, in each of which fastening means for anchoring the anti-skid device on a crawler belt can be inserted.

In another expedient development, it is advantageous if the fastening means are fastened, for example welded, perpendicular to the bottom surface in the direction of the crawler belt. This has the advantage that the fastening means do not have to be specifically attached.

In order to increase the stability against deformations, it can be favorable if the bottom parts have an L-shaped profile as viewed transversely to the first direction, wherein in each case one leg of the L-shaped profile is intended to rest in the installed state on a part of a running surface of the crawler belt.

The invention also relates to an anti-skid system comprising a device as previously discussed and fastening means which can be inserted into respective corresponding fastening points and are designed to anchor the anti-skid device to a crawler belt with a clearance in the distal direction with respect to the crawler belt.

In order to achieve the above object, a crawler belt of a crawler vehicle having one or more anti-skid devices according to the invention attached thereto is also suitable and advantageous.

The invention together with further designs and advantages is further explained below with reference to exemplary embodiments, which are illustrated in the accompanying drawings. In schematic illustrations, the drawings show:

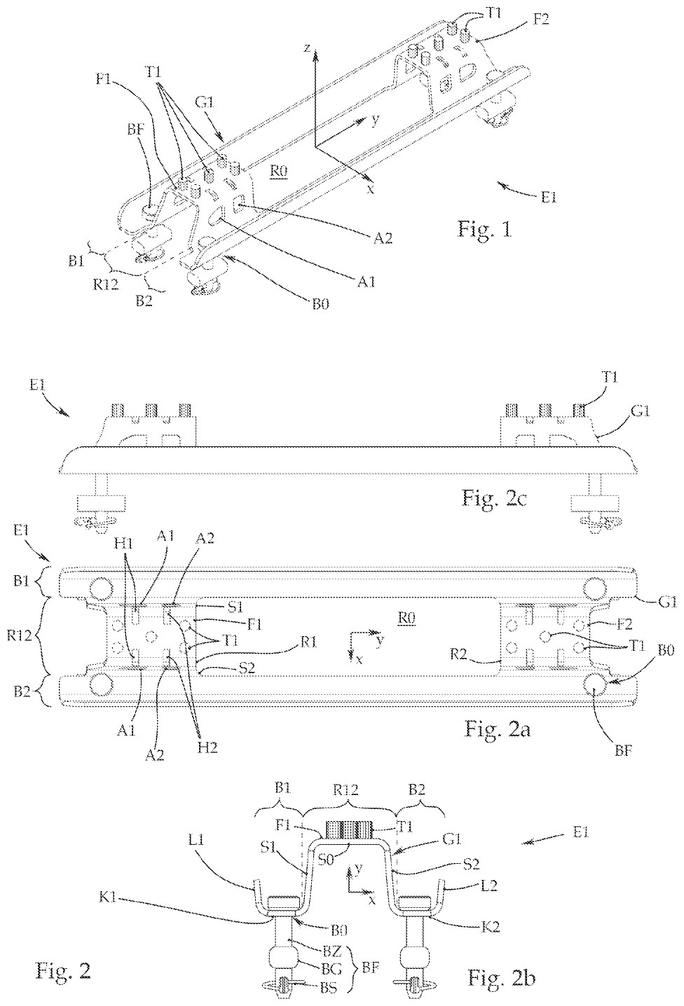

FIG. 1 a perspective view of a traction system according to a first embodiment, with traction elements in the form of pin-like projections (“spikes”);

FIG. 2 further views of the traction system of FIG. 1, namely a view from above (FIG. 2a), from the side (FIG. 2b) and a front view (FIG. 2c);

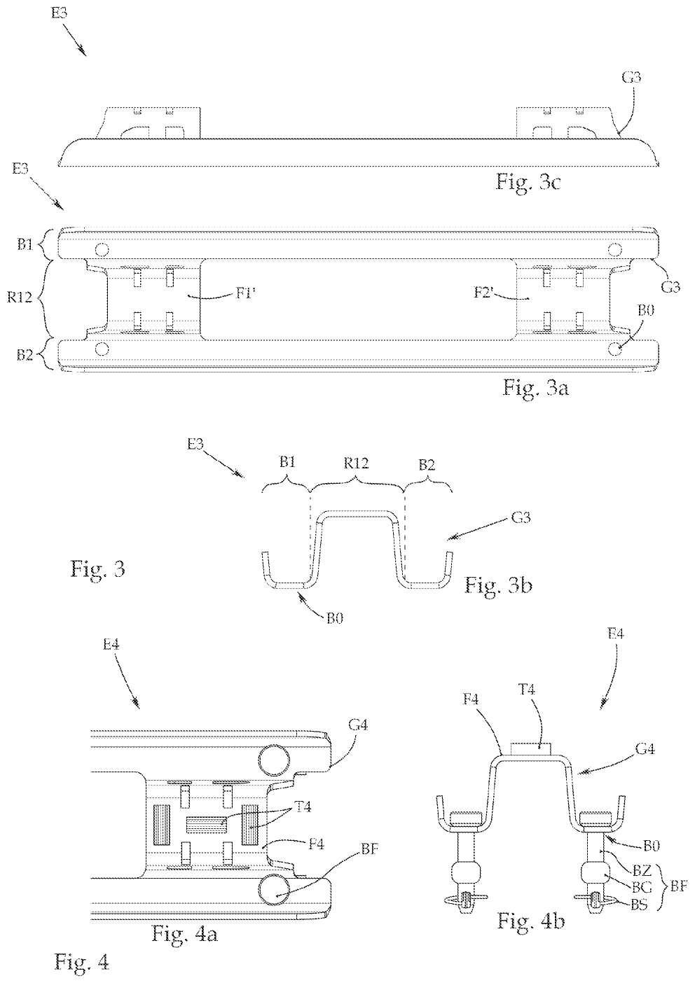

FIG. 3 an embodiment variant of the traction system without traction elements, in a view from above (FIG. 3a), from the side (FIG. 3b) and a front view (FIG. 3c);

FIG. 4 another embodiment variant of the traction system in which the traction elements are designed as short strips (“stubs”), in a partial view from above (FIG. 4a) and from the side (FIG. 4b);

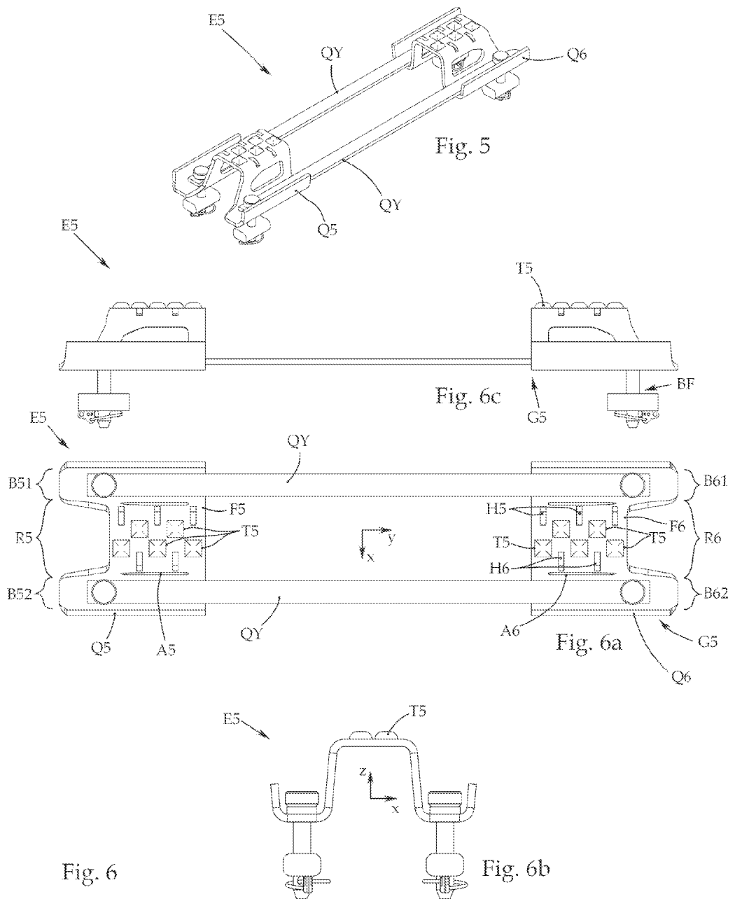

FIG. 5 a traction system according to a further embodiment in a perspective view, with a multipart base body;

FIG. 6 further views of the traction system of FIG. 5, namely a view from above (FIG. 6a), from the side (FIG. 6b) and a front view (FIG. 6c);

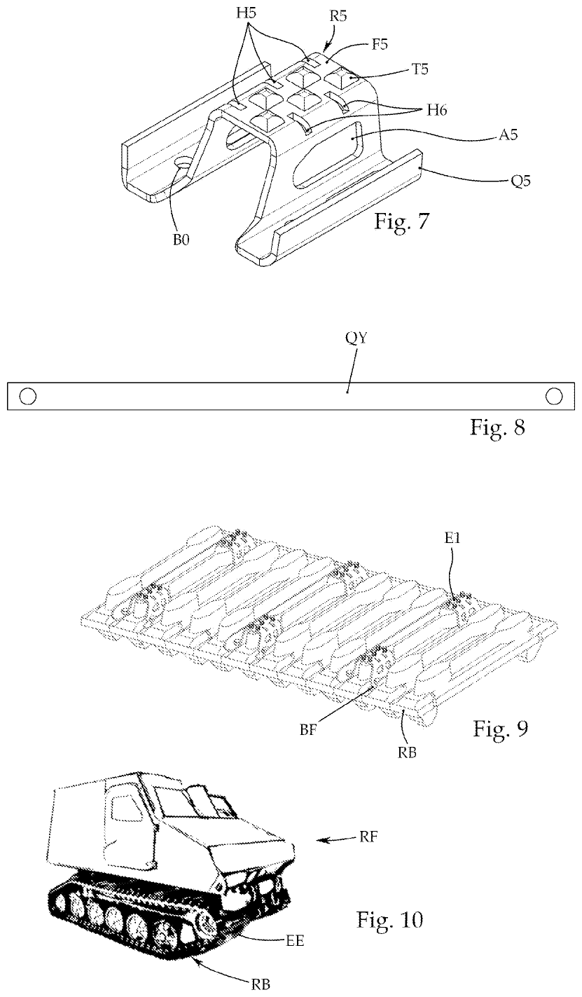

FIG. 7 a side part of the base body of the traction system of FIG. 5;

FIG. 8 a cross brace of the base body of the traction system of FIG. 5;

FIG. 9 a section of a crawler belt on which multiple traction systems of the type of FIGS. 1 and 2 are installed; and

FIG. 10 a crawler vehicle having two crawler belts.

It is understood that the embodiments described here are only used to illustrate and are not to be construed as limiting the invention. Rather, the scope of protection of the invention covers all designs which a person skilled in the art can find on the basis of the description, wherein the scope of protection is defined by the claims. In the context of this disclosure, terms such as “exemplary”, “advantageous”, or “preferable” specify features or dimensions which are especially favorable (but not essential) for the invention or embodiments thereof, and these features and dimensions can be modified freely as desired by a person skilled in the art.

In the following figures, the same reference signs are used for identical or comparable elements for the purpose of simpler explanation and illustration. In addition, the reference signs which are used in the claims are only intended to facilitate the readability of the claims and the understanding of the invention, and in no way have a character limiting the scope of protection of the invention. Wherever in this disclosure, and especially in the claims, terms of spatial position, such as “on”, “above”, “upward”, “laterally”, “vertically” and designations corresponding thereto are used, they refer to an orientation of the anti-skid device in which said device rests on a horizontal surface, and the bottom sections rest on the surface, while the (or each) rib section lifts up from said surface; see especially FIG. 1. This also corresponds to the orientation of an anti-skid device when it is in the installed position on an upper part of a drive means or a running gear component, as shown, for example, in FIG. 9. In this case, it is also understood that the orientation in an actual position can change, especially during the movement of a driven vehicle, without this being able to constitute a deviation from the scope of protection.

FIG. 1 shows a traction system E1 according to a first embodiment of an anti-skid device according to the invention, which system is intended for use on a crawler pad of a crawler drive. In FIG. 2a-2c, the traction system E1 is shown in further views along the basic directions (designated x, y, z), namely in FIG. 2a in a top view (viewing direction counter to the vertical direction z), in FIG. 2b in a side view (in the direction y) and in FIG. 2c in a front view (view counter to the direction x, which corresponds to the running direction of the crawler belt).

The traction system E1 includes a base body in the form of a base carrier G1 made of a bent sheet metal part, preferably of hardened steel sheet. At least one traction element T1 is installed on the base carrier G1, more precisely on one or more of the upper outer surfaces F1, F2.

As can be seen in FIG. 1 and especially in FIG. 2b, the base carrier G1 has a generally corrugated basic shape along the direction x, which corresponds to the “first direction” of the claims or the running direction of the crawler belt. This corrugated basic shape facilitates the traction system being placed on a rib of a crawler belt (see FIG. 4) and in this position being installed on the crawler belt, as will be described in detail further below. The base carrier G1 can be divided into several sections with regard to the corrugated basic shape, namely three sections in the embodiment of FIGS. 1 and 2, namely a first bottom section B1, a rib section R12 and a second bottom section B2.

The two bottom sections B1, B2 preferably form the parts of the traction system E1 lying on the outside as seen in the direction of travel x. They have an elongated basic shape which extends transversely to the running direction (i.e., in the direction y), for example with an L-shaped profile. The bottom sections B1, B2 advantageously each have a flat support region K1, K2 which constitutes a partial section of the bottom section in which the bottom section in question rests on a corresponding region of the running surface of the crawler belt; in addition, especially in the case of an L-shaped profile, at least one region projecting upward from the flat region and toward the outside can be provided as a reinforcing region L1, L2, for example in the form of a strip, in order to improve the stability of the base carrier against bending. Each of the support regions K1, K2 can optionally be divided into several sub-regions (see below).

The rib section R12 is arranged between the two bottom sections B1, B2, firmly connected thereto and is supported thereon. The rib section R12 has a curved shape over the bottom sections and, as can be seen in FIG. 1 and especially in FIG. 2a, is divided by at least one window R0 into two or more rib parts. In this case, an outer surface F1, F2, which carries one or more traction elements T1, is preferably provided on each of the rib parts R1, R2. The outer surfaces F1, F2, as can be seen especially well in FIG. 2, constitute an upper part S0 of the rib section (or of the rib parts) at which side flanks S1, S2 adjoin on both sides, thereby producing the connection to the bottom sections. In the shown embodiment, each of the outer surfaces is a closed, overall substantially rectangular surface; in other embodiments, one, some, or each of the outer surfaces could also have a different shape and/or be composed of a plurality of partial surfaces that are offset from one another by, for example, grooves or indentations.

The side flanks S1, S2 do not necessarily extend exactly vertically, but rather it is advantageous if they are inclined relative to the vertical direction z by a small angle so that they can better adapt to the likewise inclined rib surfaces of the crawler. In the exemplary embodiment shown, the side flanks lie, for example, at an angle of 95° to the plane of the outer surfaces; in general, expedient angles are within a range from 90° to 135°, preferably 90° to 100° or 90° to 95°.

In other embodiments (not shown), the number of sections can also be more than three, for example five in the case of a traction system which is configured for attachment to two successive ribs of a crawler belt, or optionally even more. However, a traction system according to the invention which is configured for attachment to two successive ribs of a crawler belt could also have only three sections, namely a rib section which lies above two ribs (wherein it does not have to drop down in the middle to the level of the bottom sections) between two bottom sections.

The side flanks S1, S2 can also contain voids, for example in the form of one or more window-like recesses A1, A2. On the one hand, these voids reduce the weight of the device without noticeably impairing the stability; on the other hand, they enable contaminants such as snow or sludge that penetrate into the region between side flanks and crawler belt rib to be discharged more easily to the outside, thereby achieving a self-cleaning effect. Furthermore, further voids H1, H2 can be provided in the outer surfaces F1, F2 or at their edges towards the side flanks, for example in the form of slots or notches. The recesses A1, A2 and/or voids H1, H2 are provided, for example, in pairs opposite one another, but can also be offset relative to one another along the y-direction.

In this exemplary embodiment, five traction elements T1 are provided on each outer surface F1, F2, in this case in the form of “spikes”, i.e., pin-like projections, which are formed, for example, from welded, vertically projecting strand pieces made of an advantageously hardened profile steel. The traction elements T1 in each case of an outer surface F1 or F2 are positioned, for example, in a crosswise arrangement with respect to one another. The number, relative arrangement and configuration of the traction elements T1 is variable and can be selected depending on the ground for which the respective traction system is intended and the resulting traction requirements.

Referring to FIG. 9, a traction system E1 is attached to a crawler belt RB, and is generally attached to a rib-bearing section of the crawler belt or a crawler pad of the crawler and fixed by means of fastening means BF which advantageously can be installed and removed without tools. In the exemplary embodiments shown—as can also be seen in FIGS. 2b and 4b—pins BZ with a head are used as fastening means and are inserted from top to bottom through the base carrier, namely through an opening in the bottom part B1, B2 provided as a fastening point B0, and the crawler (in which corresponding holes must be formed or produced for this purpose) and is secured to the underside of the crawler using mating pieces BG. The mating pieces BG can additionally be secured with cotter pins BS. Alternatively, fastening means can already be pre-installed, for example in the form of pins, threaded pins or the like which are fastened (e.g., welded) to a respective fastening point perpendicular to the bottom surface in the direction of the crawler belt.

In other embodiment variants (not shown), other suitable connection options known from the prior art can also be used instead of the pins, such as screw connections or clamps. For example, in the case of an anti-skid device which is intended for fastening on a tractor tire or other running gear component, the fastening can be done using screws which are screwed into the tire (possibly in holes pre-drilled for this purpose). The fastening means BF are assigned to the respective traction system, but do not constitute mandatory components of the anti-skid device according to the invention.

FIG. 10 shows by way of example a vehicle RF comprising a crawler drive. This includes two closed crawler belts RB, wherein a plurality of traction systems EE are installed at a distance from one another in succession along the running direction on each crawler belt RB; the traction systems EE are, for example, traction systems E1 of the first exemplary embodiment, but can also be other traction systems according to the invention, for example the traction systems E3, E4 or E5, or the traction systems of different types can be “mixed”.

The fastening means BF advantageously enable a clearance in the attachment of the base carrier (base body) to the crawler. This is achieved, for example, in the embodiment shown by the distance between the head of the pin BZ and the mating piece BG installed therein being greater—by, for example, a few millimeters, for example 3 mm—than the thickness that the base carrier and crawler belt have together at the point of the fastening. This results in a clearance vertically to the direction of travel or surface of the crawler belt, and due to this clearance, the traction system has the property in operation that the base part can lift off from the crawler due to centrifugal forces (or due to the deformation of the crawler pad). This has a positive influence on the self-cleaning of the system, because any deposits of snow, ice or gravel which have penetrated between the base body and the crawler can loosen and then be expelled (as a result of centrifugal movement). Thus, the clearance of the fastening pins enables a free space in the direction of centrifugal forces as the traction system lifts off from the roadway (namely when the crawler pad lifts off from the ground and is deflected upward by the deflection rollers). The free space or the clearance is expediently selected to be large enough to allow the deposits to loosen and discharge. This clearance is also advantageous with regard to the deformation during travel, because the crawler of crawler vehicles is generally very movable and the parts of the crawler are displaced and/or deformed, so that the crawler fits snugly against the ground (for example, when driving over stones, bumps or other ground textures). This deformation and/or twisting of the crawler can advantageously accommodate the traction system according to the invention, which contributes both to the reliability of the traction and to the longevity of the device. In a corresponding manner, a clearance or free space can be achieved with other types of fasteners, for example in the case of the aforementioned bolts, by screwing them in to such an extent that the distance of the screw head from the surface of the tire is greater than the thickness of the base carrier at the fastening point.

Referring again to FIGS. 1 and 2, the base body or base carrier G1 consisting of two bottom sections B1, B2 and rib parts R1, R2 is integral; for example, it is produced from a sheet metal blank which is, for example, laser-cut from raw sheet metal and then bent. Alternatively, the base carrier can also be manufactured by means of other manufacturing technologies, such as, for example, milling, injection molding, forging, or the like. However, the base body can also be multi-part, like the base body G5 of the embodiment of FIGS. 5 and 6, wherein, with regard to the manufacture of the individual components, the same applies as for the above base carrier G1, and the component are assembled in a subsequent step to form a base body (e. g. by welding) or assembled on a crawler belt or wheel during installation.

FIG. 3 shows an embodiment E3 of the traction system which does not contain traction elements, specifically in FIG. 3a in a top view, in FIG. 3b in a side view and in FIG. 3c in a front view (analogous to FIG. 2a-2c). The base body G3 has no traction elements; thus, the outer surfaces F1′ and F2′ are “naked”. Otherwise, the base body G3 is structurally identical to the base body G1 of the first exemplary embodiment. The fastening of the traction system E3 is also carried out, for example, using fastening means designed as pins (not shown in FIG. 3), as described above with reference to the traction system E1. As already mentioned, the fastening means BF (FIG. 2) are assigned to the respective traction system, but do not constitute mandatory components of the anti-skid device according to the invention in all embodiments shown here. Otherwise, the traction system E3 corresponds to the traction system E1 described further above.

FIG. 4 shows an embodiment E4 of the traction system in which an outer surface F4 having three traction elements T4 in the form of “stubs” is formed in each case, and specifically in FIG. 4a a partial view of the base carrier G4 of the traction system E4 in a top view and in FIG. 4b in a side view. These traction elements T4 (“stubs”) are horizontal components, for example short strips made of hardened steel, for example, which are each welded or permanently fastened to a side face on the relevant outer surface. The strips can run in different horizontal directions (i.e., in directions parallel to the x-y plane), as can be seen in FIG. 4, or also parallel to one another (not shown). In other respects, the traction system E4 corresponds to the traction system E1 described further above.

For permanent attachment of the traction elements T1, T4 to the outer surfaces F1, F2, F4, fastening methods of known type, such as, for example, welding, screwing, gluing or the like, can be used. Standing “spikes”, lying “stubs” or other configurations of the components fixed to the outer surface, such as, for example, U-shaped or V-shaped brackets, etc., can be used as traction elements. The number, relative arrangement and configuration of the traction elements T1, T4 can be determined according to aspects of the roadway surface, and the traction elements can be arranged on the outer surface of the base carrier symmetrically or asymmetrically with respect to the longitudinal direction of the crawler belt and/or transversely thereto. For example, the use of traction element in the form of “spikes” or “stubs” of profile steel is advantageous for achieving an increase in the surface area to improve the transmission of traction; in contrast, with round steel (“smooth” elements) noise can be reduced.

As mentioned, both the base body and the traction elements consist of hardened steel, which serves to increase the mechanical strength and wear resistance. In this case, it is generally advantageous if the hardening process of the steel only takes place after the application of the traction elements by welding, thereby resulting in a more stable fastening (welded connection). In order to additionally positively influence the wear and mechanical strength, different steel materials can be used for the base body and the traction elements.

FIGS. 5 to 8 show a further embodiment of the invention, namely a traction system E5 in which the base body is formed in several parts.

In this embodiment, the base body G5 is formed by two side parts Q5, Q6; they are connected to one another by two cross braces QY extending along the transverse direction y. FIG. 7 shows one of the side parts, the right side part Q5, in the unconnected state in a perspective view; FIG. 8 shows a cross brace QY in the unconnected state in a top view. Each side part Q5, Q6 comprises in each case one rib part R5, R6, which transitions into base parts B51, B52, B61, B62 that adjoin on both sides. The rib parts R5, R6 are separated from one another other, but, taken together, they constitute the rib section of the base body G5. Each of the base parts assigned to a rib section on a side, namely base parts B51 and B61 as well as base parts B52 and B62, are connected to one another by a cross brace QY, as a result of which these base parts together with the cross braces form bottom sections within the meaning of the invention.

The connection of the side parts or bottom parts with the cross brace QY can be accomplished using dedicated fastening means, or using the same fastening means, which also serve to fasten the traction system to the crawler belt, as is indicated in FIGS. 5 and 6.

Each rib part R5, R6 has an outer surface F5, F6 which, in this exemplary embodiment too, forms an upper part of the rib parts on which side flanks adjoin on both sides, thereby producing the connection to the bottom sections. In each side flank, for example, a window-like recess A5, A6 is formed.

In this exemplary embodiment, each outer surface F5, F6 carries five traction elements T5 in a zig-zag arrangement. The traction elements T5 are formed as elevations in the profile of the outer surfaces F5, F6, and are produced by punching the outer surfaces from the underside. The number, relative arrangement and configuration of the traction elements T1 is also variable in this design and can be selected depending on the ground for which the respective traction system is intended and on the associated traction requirements. In this case too, further voids H5, H6 can be provided in the outer surfaces F5, F6 or at the edges thereof towards the side flanks, for example in the form of slots or notches. In this case, the voids H5, H6 are offset relative to one another along the y-direction, but can also be provided in pairs opposite one another. In the arrangement shown in FIG. 5-7, a void H5, H6 is arranged in each case opposite one of the traction elements T5 with respect to the transverse direction y.

In other respects, what has been stated above regarding the first exemplary embodiment with reference to FIGS. 1 to 3 applies for the embodiment of FIGS. 5-8. In addition, it is obvious that the traction elements of the traction system E1 or E4 can also be used in the traction system E5 and vice versa, and in general all features which are not directly related to the one-piece or multi-part implementation of the base body are interchangeable between the exemplary embodiments.

A further important advantage of the anti-skid device according to the invention is that the fastening means do not protrude laterally—i.e., in relation to the y-direction—beyond the edges of the carrier body and the crawler. The solution according to the invention, specifically the fastening using fastening means guided through the base body, is advantageous especially in the case of vehicles which are limited in space, because lateral encompassing of the crawler is not necessary in order to achieve retention of the anti-skid device on the crawler belt. Especially on the inside of the crawler (i.e., the edge of the crawler which faces the vehicle), the distance to the chassis of the vehicle is often limited here, as a result of which fastening to laterally embracing components would cause a collision with the chassis. This is in contrast to many conventional anti-skid devices, which comprise the crawler on the side, which frequently leads to problems with regard to the freedom of movement of the crawler and the space requirement on the side toward the inside of the chassis of the vehicle, and often also leads to damage. In contrast, the invention makes it possible to fasten the anti-skid device without requiring additional space beyond the extension of the crawler belt transversely to the running direction (i.e., the extension in the y-direction).

Furthermore, it is possible for a plurality of traction systems to be attached laterally offset to one another, i.e., transversely to the direction of travel (running direction), which optimizes the coverage of the roadway width. For this purpose, only the connection holes on the crawler itself have to be offset correspondingly.

Another advantage of the present solution is that the installation/removal can be performed without tools and as often as desired, and the fastening pins can be made wear-resistant and long-lasting, for example made from case-hardened steel. This is advantageous especially compared to screw-in spike solutions, because the spikes can be installed repeatedly only to a limited extent.

Depending on the traction requirement, the number of systems per crawler can be varied as desired. A plurality of traction systems should expediently be arranged on a crawler belt (or generally a running gear component) in such a way as to ensure that a sufficient number of traction systems (for example, two, three, or more) are in each case immediately in contact with the ground while the belt or wheel continues to rotate. For example, eight traction systems can be attached to the crawler perimeter so that at least three of them are used in each position of the crawler belt at the contact surface with the ground.

1. An Anti-skid device for attachment to a running gear component of a drive means, especially a crawler belt of a crawler vehicle, comprising a base body,
wherein the base body has a plurality of successive sections along a first direction, which, when the anti-skid device is installed on a running gear component, corresponds to the running direction of the running gear component, namely at least two bottom sections and at least one rib section which is arranged in each case between two bottom sections and fixedly connected to said bottom sections, and which has a shape which is curved over the bottom sections and is supported thereon,
wherein the rib section or at least one of the rib sections is divided transversely to the first direction by at least one window into two or more rib parts, each having an outer surface facing away from the bottom sections,
wherein at least one fastening point for anchoring on a crawler belt is provided in the anti-skid device.

2. The device according to claim 1, characterized in that the bottom sections and rib sections are integral with one another, wherein in each case two bottom sections are connected by at least two rib parts.

3. The device according to claim 1, characterized in that the rib parts are separate components which transition into bottom parts connecting on both sides, wherein in each case the bottom parts belonging to a rib section on one side are connected to one another by a cross brace extending transversely to the first direction, whereby the bottom parts together with the cross braces form the bottom sections.

4. The device according to claim 1, characterized in that one or more traction elements protruding from the outer surface are provided on at least one of the outer surfaces.

5. The device according to claim 4, characterized in that some or all of the traction elements are one of spike-type, bracket-type, and web-type components welded to the outer surfaces of the rib parts.

6. The device according to claim 4, characterized in that at least one of the traction elements is formed as a projecting formation of the rib part.

7. The device according to claim 1, characterized in that the base body is formed from at least one shaped sheet metal parts.

8. The device according to claim 1, characterized in that the bottom sections have flat sub-sections which in the installed state are configured to rest against the surface of the crawler belt.

9. The device according to claim 8, characterized in that the bottom parts have an L-shaped profile as viewed transversely to the first direction, wherein in each case one leg of the L-shaped profile includes one of said flat sub-sections.

10. The device according to claim 1, characterized in that the rib parts have flank sections on both sides of the outer surfaces, which flank sections run at an angle of inclination to the outer surfaces and are configured to rest against rib side surfaces of the crawler belt when the anti-skid device is installed on a crawler belt, wherein window-like recesses are provided in the flank sections.

11. The device according to claim 1, characterized in that the fastening points are provided as openings in the bottom sections, by means of which fastening means for anchoring the anti-skid device can be detachably attached to the running gear component.

12. The device according to claim 1, characterized in that at least two fastening points are provided in each bottom section, in each of which fastening means for anchoring the anti-skid device on the running gear component can be inserted.

13. The device according to claim 1, characterized in that the at least one fastening point comprises a fastening means which is fastened perpendicularly to the bottom surface in the direction of the crawler belt.

14. An anti-skid system comprising an anti-skid device according to claim 1 and fastening means which can be inserted into respective corresponding fastening points and are configured to anchor the anti-skid device to a crawler belt with a clearance in the distal direction with respect to the crawler belt.

15. A crawler belt (RB) of a crawler vehicle having attached thereto at least one anti-skid device according to claim 1.
